(19) United States
(12) Patent Application Publication
(10) Pub. No.: US 2004/0086363 A1
(43) Pub. Date: May 6, 2004

(54) Apparatus and method for loading and/or unloading a transport compartment

(76) Inventor: Christoph Rohr, Heidenheim (DE)

Correspondence Address: LERNER AND GREENBERG, P.A., POST OFFICE BOX 2480, HOLLYWOOD, FL, 33022-2480, US

(21) Appl. No.: 10/694,602

(22) Filed: Oct. 27, 2003

Related U.S. Application Data
(63) Continuation of application No. PCT/EP02/04412, filed on Apr. 22, 2002.

(30) Foreign Application Priority Data
Apr. 26, 2001 (DE) 101 20 575.9
Jun. 20, 2001 (DE) 101 29 571.5

(51) Int. Cl. B65G 67/00

(52) U.S. Cl. 414/398

(57) ABSTRACT

A device for loading and/or unloading a freight transport compartment includes using at least one conveyer unit that is installed in a loading area, the conveyer unit being capable of conveying in particular several goods units simultaneously. The invention reduces the costs and increases the flexibility of a loading/unloading device by providing the conveyer unit with at least one element that can be guided into the freight transport compartment and that forms a positioning surface for the goods units.

### CROSS-REFERENCE TO RELATED APPLICATION

This application is a continuation of copending International Application No. PCT/EP02/04412, filed Apr. 22, 2002, which designated the United States and was not published in English.

### BACKGROUND OF THE INVENTION

Field of the Invention

The invention is based on an apparatus and method for loading and/or unloading a transport compartment.

Apparatuses of the generic type for loading and unloading transport compartments of commercial motor vehicles, using conveyor belts, are known. The apparatuses have a first conveyor belt installed in a loading area and a second conveyor belt installed in the transport compartment. To load a transport compartment, a plurality of goods units to be transported is placed on the conveyor belt installed in the loading area. The conveyor belts in the loading area and transport compartment are, then, driven synchronously and the goods units are conveyed into the transport compartment. Furthermore, it is known to use lift trucks to load a transport compartment sequentially with individual or a few goods units. In such a case, the lift truck picks up a goods unit from goods-providing measures, moves forward with the goods unit into the transport compartment, sets down the goods unit, moves backward out of the transport compartment, and picks up a further goods unit for transport into the transport compartment, specifically, until the transport compartment has been loaded in the desired manner.

### SUMMARY OF THE INVENTION

It is accordingly an object of the invention to provide an apparatus and method for loading and/or unloading a transport compartment that overcome the hereinafore-mentioned disadvantages of the heretofore-known devices and methods of this general type and that provides an inexpensive apparatus of the generic type that can be used flexibly and is efficient.

With the foregoing and other objects in view, there is provided, in accordance with the invention, an apparatus for at least one of loading and unloading goods units to and from a transport compartment, including at least one conveying unit to be installed in a loading area, the conveying unit simultaneously conveying the goods units and having at least one insertion device adapted to be inserted into the transport compartment, the insertion device forming an area on which the goods units are to be placed.

The invention is based on an apparatus and method for loading and/or unloading a transport compartment, in particular, of a commercial motor vehicle, with at least one conveying unit that is installed in a loading area and through which, in particular, a plurality of goods units can be conveyed simultaneously.

It is proposed that the conveying unit have at least one device that can be inserted into the transport compartment and forms an area on which the goods units can be put. The transport compartment can be loaded and/or unloaded completely with a large number of goods units in a few operations, preferably, in one operation, in a short time. Waiting times in loading areas can be reduced, and the level of utilization of commercial motor vehicles can be increased and, in particular, costly re-equipment of transport compartments with additional special apparatuses can be avoided. Furthermore, advantageous loading and/or unloading of numerous different standard transport compartments and, as a result, particularly flexible use can be achieved. The apparatus according to the invention can be used in different areas of application appearing expedient to those skilled in the art, such as when loading and unloading rail containers, ship's containers, and so on, but, in particular, when loading and unloading commercial motor vehicle transport compartments, which can frequently be loaded only in their longitudinal direction.

The loading/unloading measures can have various configurations appearing to be expedient to those skilled in the art, for example, they can be formed by a movable carrier plate, by movable plate segments or slats, and/or by rails and so on. If the measures can be lowered at least partly and, advantageously, completely in the loading area, it is, advantageously, possible to move onto these when setting down goods units, for example, with a lift truck.

In accordance with another feature of the invention, supporting rollers can be mounted on the measures, through which the measures can be supported, in particular, in the transport compartment. Large moments acting on the measures because of long lever arms can be avoided and an inexpensive construction, in particular, mounting of the measures, can be achieved.

In accordance with a further feature of the invention, there are provided a drive unit disposed at the insertion device and at least one conveyor connected to and driven by the drive unit.

In accordance with an added feature of the invention, the drive unit drives the conveyor in a direction of the transport compartment at a higher speed than the insertion device in a direction facing away from the transport compartment.

The goods units can be pushed or else lifted by the measures inserted into the transport compartment. However, the measures, particularly advantageously, has at least one conveying device that can be driven by a drive unit, for example, one or more conveyor belts, by which the goods units can be conveyed from the measures into the transport compartment. If the conveying device can be driven by the drive unit in the direction of the transport compartment at a higher speed than the measures in the direction facing away from the transport compartment, gap-free loading of the transport compartment in the loading direction can be achieved.

To save components, installation space, expenditure on mounting, and costs, the drive unit of the conveying device can, advantageously, be implemented in one piece with a drive unit of the measures. The conveying device and the measures can, in this case, be driven in different directions and at different speeds through a gear unit.

In accordance with an additional feature of the invention, there is provided a lifting unit connected to the insertion device for lifting the insertion device.

If the measures can be lifted by a lifting unit, the measures can be moved in a lowered state to be loaded with goods units, and, then, the goods units can be lifted off an adjacent base so that a particularly narrow configuration of the measures is achieved and, nevertheless, friction between the goods units and an adjacent base can be avoided. Furthermore, instead of a platform, individually spaced, in particular, lowerable, plate segments can, advantageously, be used transversely with respect to the loading/unloading direction, it being possible for the plate segments to be produced with a low weight and with little expenditure on material as compared with a closed platform. Furthermore, to adapt to different boundary conditions, such as, in particular, transport compartments of different widths and/or, in the event of transverse loading, transport compartments of different lengths, a different number of plate segments can be used for loading and/or unloading.

In accordance with yet another feature of the invention, the conveying unit can have at least one retaining device that, during a movement of the measures out of the transport compartment, can be moved in front of the goods units, counter to the direction of movement of the measures. The goods units can be pushed off the measures in a constructionally simple manner as the measures are guided out of the transport compartment. If at least two measures are disposed transversely with respect to the loading/unloading direction, the retaining device can advantageously be disposed between the measures. In principle, however, it is also conceivable to guide retaining device in front of the goods units from the side or from above.

If the measures are disposed beside a railroad track and configured such that they can be moved and, in particular, driven substantially transversely with respect to the railroad track, rail containers already standing on the railroad tracks can, advantageously, be loaded quickly and effectively.

If the measures have at least a second degree of freedom of movement in addition to a first degree of freedom of movement, the apparatus can be matched flexibly to a position of the transport compartment and/or to a position of the goods units provided. The measures can be configured to be pivoted about one or more axes and moved translationally in one or more directions. It is also possible to mount the measures in a floating manner so that they can automatically adapt to a position of the transport compartment and/or to goods units provided.

With the objects of the invention in view, there is also provided an apparatus for at least one of loading and unloading goods units to and from a transport compartment, including at least one conveying unit to be installed in a loading area, the conveying unit simultaneously conveying the goods units and having at least one means inserting into the transport compartment, the inserting means forming an area on which the goods units are to be placed.

With the objects of the invention in view, in a loading area having goods units and a transport compartment, there is also provided an apparatus for at least one of loading and unloading the goods units to and from a transport compartment in a loading and unloading direction, the apparatus including at least one conveying unit installed in the loading area, the conveying unit simultaneously conveying the goods units and having at least one insertion device insertable into the transport compartment, the insertion device forming an area on which the goods units are placed.

With the objects of the invention in view, there is also provided a method for at least one of loading and unloading goods units to and from a transport compartment, including the steps of installing at least one conveying unit at a loading area, providing a conveying unit with at least one insertion device adapted to be inserted into the transport compartment, the insertion device forming an area on which the goods units are to be placed, and simultaneously conveying the goods units with the conveying unit at least one of into and out from the transport compartment.

With the objects of the invention in view, there is also provided a method for at least one of loading and unloading goods units to and from a transport compartment, including the steps of fixedly installing at least one conveying unit at a loading area, providing a conveying unit with at least one insertion device adapted to be inserted into the transport compartment, the insertion device forming an area on which the goods units are to be placed, and simultaneously conveying the goods units with the conveying unit at least one of into and out from the transport compartment by moving the insertion device at least one of into and out from the transport compartment.

Other features that are considered as characteristic for the invention are set forth in the appended claims.

Although the invention is illustrated and described herein as embodied in an apparatus and method for loading and/or unloading a transport compartment, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a fragmentary, partially cross-sectional and partially elevational side view of an apparatus according to the invention during a loading operation before a support platform is moved into a transport compartment;

FIG. 2 is a fragmentary, partially cross-sectional and partially elevational side view of the apparatus of FIG. 1 with the support platform raised;

FIG. 3 is a fragmentary, partially cross-sectional, partially hidden, and partially elevational side view of the apparatus of FIG. 2 with the support platform moved in;

FIG. 4 is a fragmentary, partially cross-sectional, partially hidden, and partially elevational side view of the apparatus of FIG. 3 during unloading of the support platform;

FIG. 5 is a fragmentary, partially cross-sectional and partially hidden view of the support platform of the apparatus of FIGS. 1 to 4;

FIG. 6 is a fragmentary, plan view of the support platform of FIGS. 1 to 4 with goods units;

FIG. 7 is a fragmentary, plan view of an alternative embodiment of the apparatus of FIG. 1 with floor slats for loading rail containers;

FIG. 8 is a fragmentary, partially cross-sectional, partially hidden, and partially elevational side view of the apparatus of FIG. 7 along section line VIII-VIII in FIG. 7 with the floor slats moved in and with goods units; and

FIG. 9 is a fragmentary, partially cross-sectional, partially hidden, and partially elevational side view of the apparatus of FIG. 7 along section line VIII-VIII in FIG. 7 during the unloading of the floor slats and with the retaining device extended.

### DESCRIPTION OF THE PREFERRED EMBODIMENTS

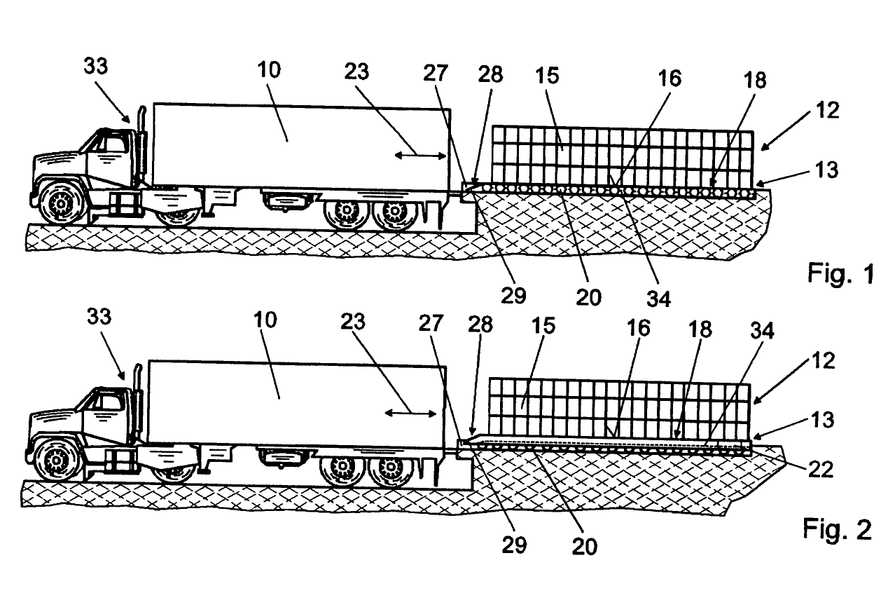

Referring now to the figures of the drawings in detail and first, particularly to FIG. 1 thereof, there is shown an apparatus, illustrated schematically, for loading and unloading transport compartments 10, specifically, commercial motor vehicles 33. The apparatus has a conveying unit 13 that is installed in a loading area 12 and through which a plurality of goods units 15 can be conveyed simultaneously from the loading area into the transport compartment 10.

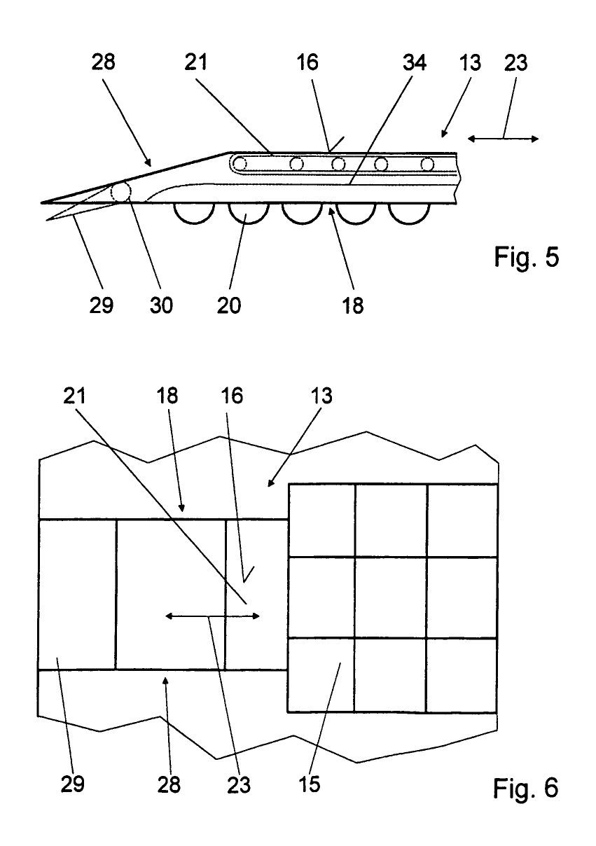

The conveying unit 13 has a support platform 18 that can be inserted into the transport compartment 10, which has an integrated conveyor belt 21 that can be driven by an electric drive unit 22 (FIGS. 5 and 6), and forms a set-down area 16 for the goods units 15. The support platform 18, which is about 2.2 m wide and about 12 m long, can be lowered in a recess 27 in the loading area 12 and, with a floor of the loading area 12, forms a plane in the lowered state so that it is, advantageously, possible to move onto the support platform 18 when setting down the goods units 15.

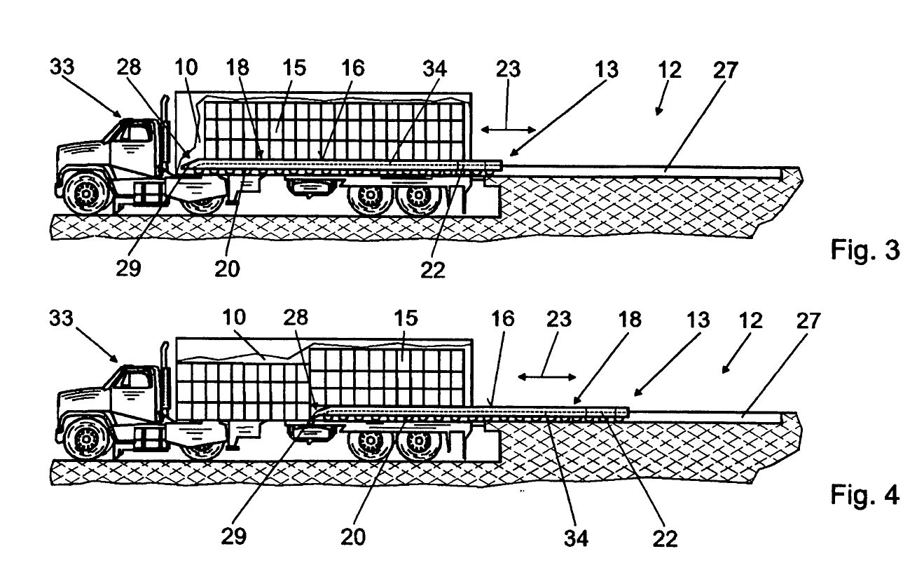

On the support platform 18, supporting rollers 20 are mounted on an integrated hydraulic lifting unit 34. Instead of a lifting unit 34 integrated in the support platform 18, a lifting unit could also be integrated in the loading area 12. Once the support platform 18 has been loaded with the goods units 15, the support platform 18 and the goods units 15 set down on the latter are lifted by the lifting unit 34 and the supporting rollers 20 (FIG. 2). The support platform 18, driven by the electric drive unit 22, is, then, moved over the supporting rollers 20 into the transport compartment 10 (FIG. 3).

To achieve as stepless a transition as possible between the support platform 18 and a floor of the transport compartment 10, after the support platform 18 has been moved into the transport compartment 10, a pivotably mounted 30 end piece 29 of a wedge-like area 28 formed by a free end of the support platform 18 is pivoted in the direction of the floor of the transport compartment 10 (FIG. 6). Then, the conveyor belt 21 is driven by the drive unit 22 and, at the same time, the support platform 18 is moved out of the transport compartment 10 (FIGS. 4 and 5), and to be specific, the conveyor belt 21 is driven by the drive unit 22 in the direction of the transport compartment 10 at a speed that is minimally higher than the support platform 18 is driven out of the transport compartment 10. To reach the different speeds of the conveyor belt 21 and of the support platform 18, these are connected to the drive unit 22 through a non-illustrated gear unit. The goods units 15 are conveyed by the conveyor belt 21 into the transport compartment 10 from the support platform 18 over the wedge-like region 28 and the end piece 29 of the support platform 18, and, in the process, on account of the different speeds of the conveyor belt 21 and the support platform 18, are positioned without gaps in the longitudinal direction of the transport compartment 10.

During the unloading operation of a transport compartment 10, not specifically illustrated, the support platform 18 is pushed into the transport compartment 10 with the end piece 29 pivoted down under the goods units 15, and the goods units 15 are drawn onto the support platform 18 by the conveyor belt 21.

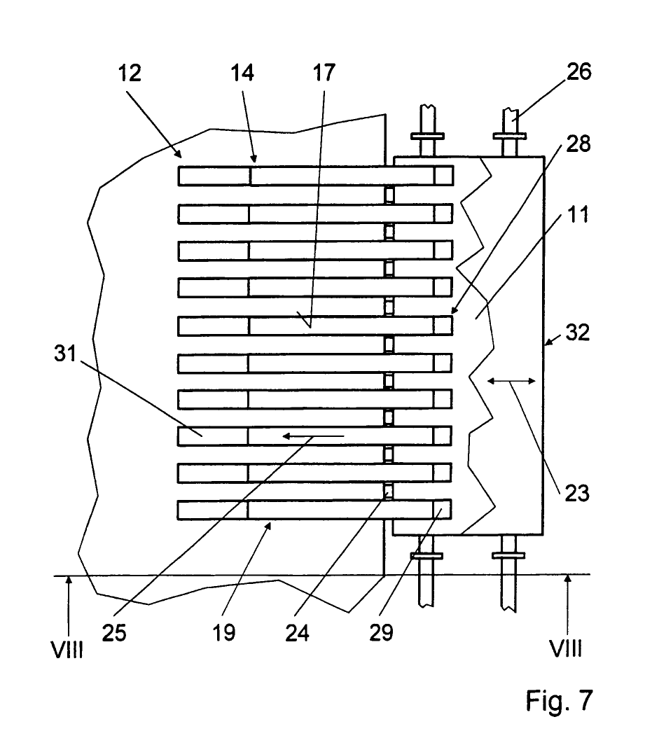

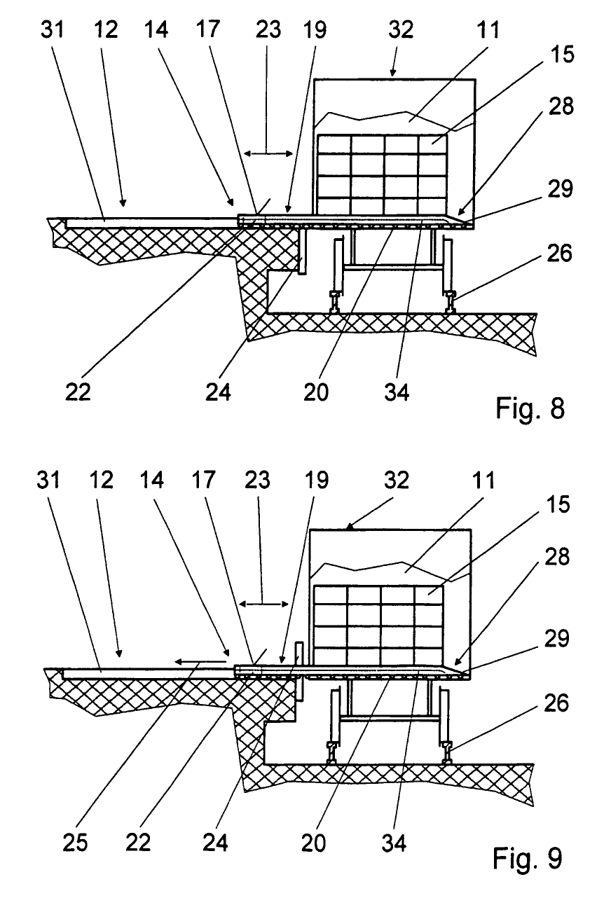

An alternative apparatus for loading and unloading transport compartments 11 in rail containers 32 is illustrated in FIGS. 7 to 9. Components that substantially remain the same are in principle numbered with the same reference symbols. Furthermore, with respect to features and functions that remain the same, reference can be made to the description relating to the exemplary embodiment in FIGS. 1 to 6. The following description is restricted substantially to the differences from the exemplary embodiment in FIGS. 1 to 6.

In a loading area 12 of a railroad platform beside a railroad track 26, the apparatus has ten floor slats 19 that are disposed beside one another transversely with respect to the loading/unloading direction 23, which are mounted such that they can be driven transversely with respect to the railroad track 26 and form a set-down area 17 for goods units 15 to be transported. The individual floor slats 19 can be lowered in recesses 31 in the loading area 12 and, corresponding to the support platform 18 of the exemplary embodiment in FIGS. 1 to 6, are configured such that they can be lifted by supporting rollers 20 and by a lifting unit 34.

Once the floor slats 19 with goods units 15 have been moved into the transport compartment 11, transversely with respect to the railroad tracks 26, retaining measures 24 disposed between the floor slats 19 on a wall of the railroad platform that points in the direction of the rail container 32 are moved vertically upward hydraulically so that the measures 24 come to lie in front of the goods units 15, counter to a direction of movement 25 of the floor slats 19 out of the transport compartment 11 (FIG. 9). The floor slats 19 can, then, be moved out of the transport compartment 11 of the rail container 32, and the goods units 15 can be stripped off the floor slats 19 by the retaining measures 24 and positioned in the transport compartment 11. To achieve low sliding friction between the floor slats 19 and the goods units 15 as the latter are stripped off, the set-down area 17 of the floor slats 19 is treated appropriately, to be specific, it is coated with a specific plastic forming a sliding layer. Instead of a sliding layer, in principle, antifriction elements can also be used.

I claim:

1. An apparatus for at least one of loading and unloading goods units to and from a transport compartment, comprising:
at least one conveying unit to be installed in a loading area, said conveying unit simultaneously conveying the goods units and having at least one insertion device adapted to be inserted into the transport compartment, said insertion device forming an area on which the goods units are to be placed.

2. The apparatus according to claim 1, wherein said insertion device is adapted to at least partly lower in the loading area.

3. The apparatus according to claim 1, wherein said insertion device has supporting rollers for supporting said insertion device.

4. The apparatus according to claim 1, further comprising:
a drive unit disposed at said insertion device; and
at least one conveyor connected to and driven by said drive unit.

5. The apparatus according to claim 1, further comprising:
a drive unit disposed at said insertion device; and
at least one conveying means connected to and driven by said drive unit.

6. The apparatus according to claim 4, wherein said drive unit drives said conveyor in a direction of the transport compartment at a higher speed than said insertion device in a direction facing away from the transport compartment.

7. The apparatus according to claim 5, wherein said drive unit drives said conveying means in a direction of the transport compartment at a higher speed than said insertion device in a direction facing away from the transport compartment.

8. The apparatus according to claim 4, wherein:
said insertion device has a drive unit; and
said drive unit of said conveyor is in one piece with said drive unit of said insertion device.

9. The apparatus according to claim 5, wherein:
said insertion device has a drive unit; and
said drive unit of said conveying means is in one piece with said drive unit of said insertion device.

10. The apparatus according to claim 1, further comprising a lifting unit connected to said insertion device for lifting said insertion device.

11. The apparatus according to claim 1, wherein:
goods units are loaded and unloaded to and from a transport compartment in a loading and unloading direction; and
said insertion device is at least two insertion devices disposed transversely with respect to the loading and unloading direction.

12. The apparatus according to claim 1, wherein said conveying unit has at least one retainer moveable in front of the goods units counter to the direction of movement of said insertion device during a movement of said insertion device out of the transport compartment.

13. The apparatus according to claim 1, wherein said conveying unit has at least one means for retaining the goods units, said retaining means moveable in front of the goods units counter to the direction of movement of said insertion device during a movement of said insertion device out of the transport compartment.

14. The apparatus according to claim 1, wherein said insertion device is to be disposed beside a railroad track and is to be mounted moveably substantially transversely with respect to the railroad track.

15. An apparatus for at least one of loading and unloading goods units to and from a transport compartment, comprising:
at least one conveying unit to be installed in a loading area, said conveying unit simultaneously conveying the goods units and having at least one means inserting into the transport compartment, said inserting means forming an area on which the goods units are to be placed.

16. In a loading area having goods units and a transport compartment, an apparatus for at least one of loading and unloading the goods units to and from a transport compartment in a loading and unloading direction, the apparatus comprising:
at least one conveying unit installed in the loading area, said conveying unit simultaneously conveying the goods units and having at least one insertion device insertable into the transport compartment, said insertion device forming an area on which the goods units are placed.

17. A method for at least one of loading and unloading goods units to and from a transport compartment, which comprises:
installing at least one conveying unit at a loading area;
providing a conveying unit with at least one insertion device adapted to be inserted into the transport compartment, the insertion device forming an area on which the goods units are to be placed; and
simultaneously conveying the goods units with the conveying unit at least one of into and out from the transport compartment.

18. A method for at least one of loading and unloading goods units to and from a transport compartment, which comprises:
fixedly installing at least one conveying unit at a loading area;
providing a conveying unit with at least one insertion device adapted to be inserted into the transport compartment, the insertion device forming an area on which the goods units are to be placed; and
simultaneously conveying the goods units with the conveying unit at least one of into and out from the transport compartment by moving the insertion device at least one of into and out from the transport compartment.
